(19) United States
(12) Patent Application Publication
(10) Pub. No.: US 2008/0247546 A1
(43) Pub. Date: Oct. 9, 2008

(54) METHOD AND APPARATUS FOR PROTECTING DIGITAL CONTENT STORED IN USB MASS STORAGE DEVICE USING TIME INFORMATION

(75) Inventors: Bong-seon KIM, Seongnam-si (KR); Jun-bum Shin, Suwon-si (KR); Chang-sup Ahn, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/949,230

(22) Filed: Dec. 3, 2007

(30) Foreign Application Priority Data
Apr. 6, 2007 (KR) 10-2007-0034417

(51) Int. Cl. H04L 9/06

(52) U.S. Cl. 380/260

(57) ABSTRACT

Provided is a method of preventing digital content stored in a universal serial bus (USB) mass storage (UMS) device from being distributed without restriction. In the method, registration data is encrypted in order to allow a UMS device to decrypt and use digital content using time information only within a predetermined term of validity. Accordingly, even if encrypted registration data of a UMS device is disclosed, it is possible to make it difficult for unauthorized devices to store the registration data, thereby preventing content of the UMS device from being distributed without restriction.

### CROSS-REFERENCE TO RELATED PATENT APPLICATIONS

This application claims the benefit of Korean Patent Application No. 10-2007-0034417, filed on Apr. 6, 2007, in the Korean Intellectual Property Office, the disclosure of which is incorporated herein in its entirety by reference.

### BACKGROUND OF THE INVENTION

1. Field of the Invention

The present invention relates to a method of protecting digital content, and more particularly, to a method of preventing indiscriminate distribution of digital content stored in a universal serial bus Mass Storage (UMS) device.

2. Description of the Related Art

Peripheral devices connected to a host system are allowed to use a serial port, a parallel port, or a universal serial bus (USB) port as a communication channel for data exchange. To this end, an appropriate host system drivers, communication protocols, and application programs must be installed in each peripheral device. However, it is very inefficient and inconvenient to install all required drivers and related programs in order to connect various devices to the host system. Furthermore, general users would have difficulties installing drivers and programs. In order to remove such an inconvenience, in the case of the USB port, a USB mass storage (UMS) class is defined and most general operating systems, such as Windows XP, basically provide the UMS class. Thus, a peripheral device subject to a UMS standard can be easily connected to the host system without installing an additional driver or application program in the device.

Since digital content can be repeatedly copied without restriction, the importance of and an interest in digital content security techniques has increased. In order to protect content stored in a host system, authentication information is necessary to prove that a peripheral device having a right to use the content belongs to an authorized user or entity. To this end, a secret key must be securely shared between a host and peripheral devices. However, when a UMS device is connected to a USB host, the UMS device simply operates as a storage device and thus cannot actively perform a security function. For example, if a portable USB hard disc, which is a representative example of the UMS device, is connected to the USB host, the USB device cannot encrypt or conceal particular files but simply operates as a passive storage device having a large capacity. Also, a personal video recorder (PVR) operates as an active device unless it is connected to the USB host. However, once the PVR is connected to the USB host, the firmware in the PVR ends, and therefore, the USB host recognizes the PVR just as a passive UMS device. Accordingly, content stored in the UMS device is very likely to be distributed by the USB host in an unlimited fashion, and therefore, development of a method of preventing this problem is required.

### SUMMARY OF THE INVENTION

The present invention provides a method and apparatus for protecting content stored in a universal serial bus mass storage (UMS) device by encrypting and storing registration data (authentication information allowing use of the content) and providing a right to use the content only to devices that decrypt the encrypted data within a predetermined term of validity.

A first aspect of the present invention is a method of allowing a universal serial bus mass storage (UMS) device to manage its registration data, the method including encrypting the registration data so that the registration data is allowed to be decrypted and used within a predetermined term of validity, and storing the encrypted data in a predetermined location known to a universal serial bus (USB) device that accesses the UMS device, wherein the registration data is necessary to use encrypted content of the UMS device.

The encrypting of the registration data may include producing a symmetric key according to a predetermined algorithm, using information regarding a current time, and encrypting the registration data using the symmetric key. The algorithm may allow the same symmetric key to be produced using information regarding any time that falls within a predetermined period of time beginning at the current time.

The encrypting of the registration data may include encrypting the information regarding the current time and the registration data using a common key that is shared with a predetermined USB host.

Another aspect of the present invention is a computer readable medium having recorded thereon a program for executing the method of managing registration data.

Another aspect of the present invention is an apparatus for managing registration data of a universal serial bus mass storage (UMS) device, the apparatus including an encryption unit encrypting the registration data so that the registration data is allowed to be decrypted and used within a predetermined term of validity, and storing the encrypted data in a predetermined location known to a universal serial bus (USB) device that accesses the UMS device. Here, the registration data is necessary to use encrypted content of the UMS device.

Another aspect of the present invention is a method of allowing a universal serial bus (USB) host to register a USB mass storage (UMS) device, the method including synchronizing time with the UMS device, and selectively obtaining registration data of the UMS device based on information regarding a current time. Here, the registration data is necessary to use encrypted content of the UMS device.

The selective obtaining of the registration data may include producing a symmetric key by processing information regarding the current time according to a predetermined key generation algorithm, and decrypting encrypted registration data stored in a predetermined location of the UMS device using the symmetric key. Here, the key generation algorithm may allow the same symmetric key to be produced using information regarding any time that falls within a predetermined period of time.

The selectively achieving of the registration data may include decrypting the registration data and time information using a common key that is shared with the UMS device, where the registration data is encrypted and stored in a predetermined location of the UMS device; and comparing the decrypted time information with information regarding the current time, and storing the decrypted registration data if the result of comparison reveals that the current time falls within a predetermined term of validity as from the decrypted time information, and revoking the decrypted registration data if the result of comparison reveals that the current time does not fall within the term of validity.

The synchronizing of the time with of the UMS device with time may include performing synchronization using time information received from an external time server.

Another aspect of the present invention is a computer readable medium having recorded thereon a program for executing the method of registering a UMS mass storage device.

Another aspect of the present invention is a universal serial bus (USB) host device comprising a time synchronization unit synchronizing time with a USB mass storage (UMS) device, and a registration data processor selectively processing registration data of the UMS device based on information regarding a current time, wherein the registration data is necessary to use encrypted content of the UMS device.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of an exemplary environment to which the present invention is applied;

FIG. 2 is a flowchart illustrating a method of managing registration data, according to an exemplary embodiment of the present invention;

FIG. 3 is a flowchart illustrating a method of encrypting registration data, according to an exemplary embodiment of the present invention;

FIG. 4 is a flowchart illustrating a method of encrypting registration data, according to another exemplary embodiment of the present invention;

FIG. 5 is a block diagram of a universal serial bus mass storage (UMS) device according to an exemplary embodiment of the present invention;

FIG. 6 is a block diagram of a UMS device according to another exemplary embodiment of the present invention;

FIG. 7 is a flowchart illustrating a method of allowing a USB host to register a UMS device, according to an exemplary embodiment of the present invention;

FIG. 8 is a flowchart illustrating a method of allowing a USB host to process encrypted registration data, according to an exemplary embodiment of the present invention;

FIG. 9 is a flowchart illustrating a method of allowing a USB host to process encrypted registration data, according to another exemplary embodiment of the present invention;

FIG. 10 is a block diagram of a USB host according to an exemplary embodiment of the present invention; and

FIG. 11 is a block diagram of a USB host according to another exemplary embodiment of the present invention.

### DETAILED DESCRIPTION OF THE INVENTION

The present invention will now be described more fully with reference to the accompanying drawings, in which exemplary embodiments of the invention are shown.

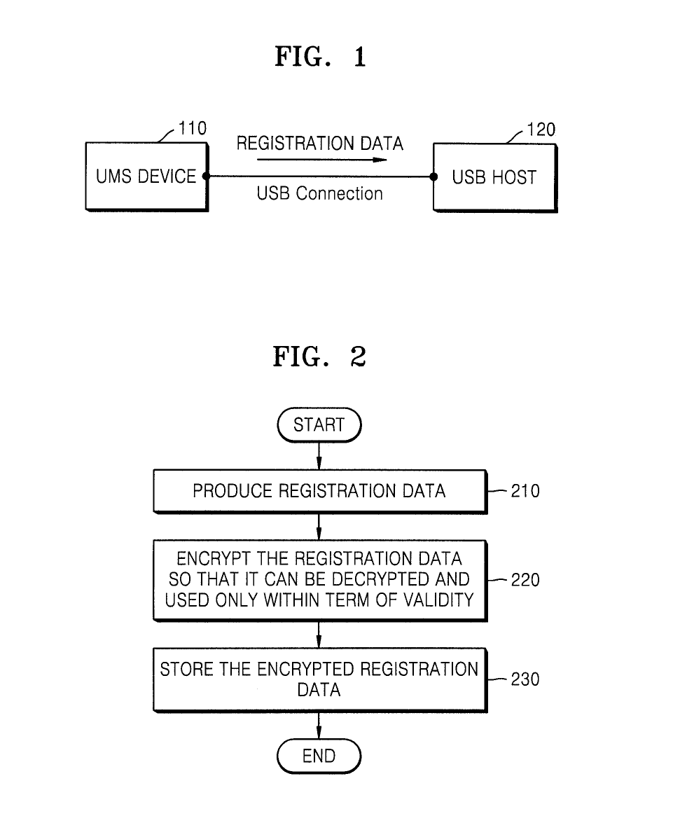

FIG. 1 is a block diagram of an exemplary environment to which the present invention is applied. As illustrated in FIG. 1, a universal serial bus (USB) host and a USB mass storage (UMS) device are connected via a USB port. The UMS device encrypts its content and stores the encrypted content. Also, the UMS device stores registration data in a predetermined location. The registration data is authentication information necessary to legally use the encrypted content of the MS device. The registration data is generated and stored in a predetermined location as per a user's request before the USB host is connected to the UMS device, that is, when the UMS device actively functions.

For example, when the UMS device encrypts and stores its content using a content key and encrypts the content key using its device key, the USB host can obtain the content key and thus freely use all the content of the UMS device if the USB host holds the content key of the UMS device. In this case, the device key of the UMS device may be registration data.

A device that has the registration data, i.e., a device that registers the UMS device, can freely use content stored in the UMS device. Accordingly, the registration data is preferably encrypted and stored. If the USB host successfully decrypts the encrypted registration data, it stores the registration data in a secure place. However, it is difficult to prevent the content in the UMS device from being distributed without limitation if an unauthorized person obtains the registration data by cracking the encrypted registration data since the encrypted registration data is disclosed via a USB channel during transmission of this data from the UMS device to the USB host.

Thus, the present invention is designed to effectively encrypt registration data so that unauthorized devices cannot register a UMS device without limitation even if the encrypted registration data is disclosed.

FIG. 2 is a flowchart illustrating a method of managing registration data, according to an embodiment of the present invention.

In operation 210, a UMS device generates registration data in response to a user's request. That is, the user requests generation of registration data via a user interface of the UMS device in order to register the UMS device with a USB host.

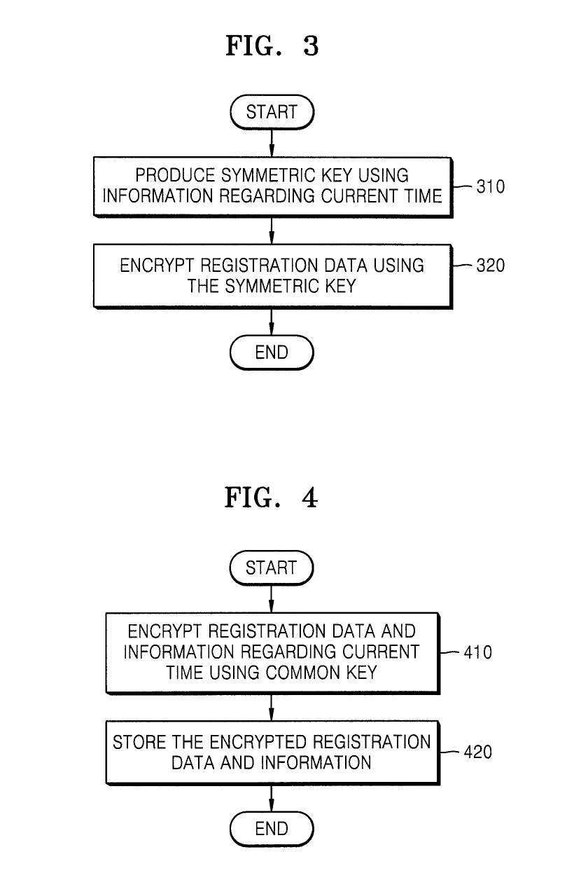

In operation 220, the UMS device encrypts the registration data so that it can be decrypted only within a predetermined term of validity. That is, the registration data is encrypted using information regarding a current time, i.e., a point of time when encryption is performed, so that the registration data can be decrypted only within a predetermined term of validity as from the current time. Encryption will be described in greater detail with reference to FIGS. 3 and 4.

In operation 230, the UMS device stores the encrypted registration data in a predetermined place, i.e., a location that the USB host accesses in order to read the registration data.

After the registration data is encrypted and stored as described above, even if the encrypted registration data is obtained, a UMS device cannot be registered when the encrypted registration data is decrypted after the term of validity. Thus, it is possible to prevent unauthorized devices from registering a UMS device without any restriction.

FIG. 3 is a flowchart illustrating a method of encrypting registration data according to an embodiment of the present invention.

In operation 310, a symmetric key is generated using information regarding a current time. That is, the symmetric key is generated using the information regarding the current time information as a parameter of a key generation algorithm. In this case, the key generation algorithm is capable of generating the same symmetric key using information regarding any time that falls within a predetermined term of validity as a parameter. Such a key generation algorithm can be embodied in various ways, that is, the type of key generation algorithm is not limited.

In operation 320, registration data is encrypted using the symmetric key.

As described above, if registration data is encrypted and a device that desires to decrypt the encrypted registration data is constrained to use information regarding a point of time when decryption is to be performed in order to produce a symmetric key for decryption, then the encrypted registration data can be decrypted only within a term of validity. Such a constraint may be realized using software for registration of a UMS device, which is provided together with the UMS device.

FIG. 4 is a flowchart illustrating a method of encrypting registration data according to another embodiment of the present invention.

In operation 410, registration data and information regarding current time are encrypted together by using a common key shared with a USB host.

In operation 420, the encrypted results are stored in a predetermined location, i.e., a location for storing the registration data.

If registration data is encrypted according to the current embodiment, all devices having a common key can decrypt the encrypted registration data irrespective of a term of validity. However, the purpose of the present invention can be achieved by constraining the registration data so that it cannot be stored if time information that a device obtains by performing decryption is compared with information regarding a point of time when decryption was performed, and the comparison result reveals that the term of validity has expired. Such a constraint may be realized using software for registration of a UMS device, which is provided together with the UMS device.

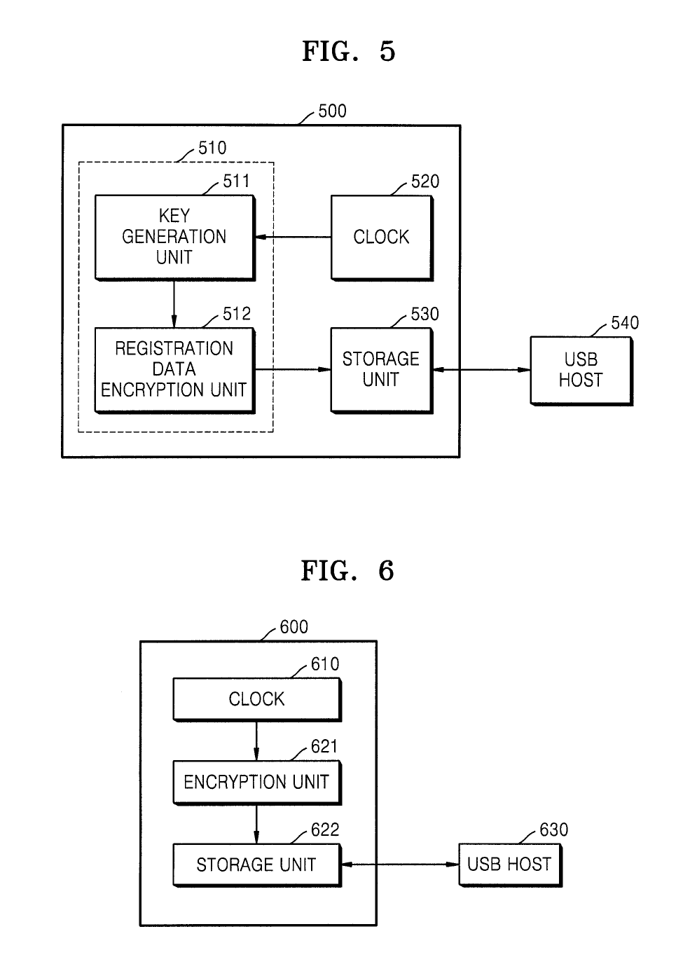

FIG. 5 is a block diagram of a UMS device 500 according to an embodiment of the present invention. As illustrated in FIG. 5, the UMS device 500 includes an encryption unit 510, a clock 520, and a storage unit 530.

The encryption unit 510 encrypts registration data of the UMS device 500 so that the encrypted registration data can be decrypted and used only within a predetermined term of validity. The encryption unit 510 includes a key generation unit 511 and a registration data encryption unit 512. The clock 520 provides time information to the encryption unit 510, and can obtain time information from a remote time server (not shown) for time synchronization with a USB host 540.

The key generation unit 511 produces a symmetric key using the time information received from the clock 520 as a parameter. The registration data encryption unit 512 encrypts the registration data using the symmetric key.

The storage unit 530 stores the encrypted registration data in a predetermined location. The USB host 540 obtains the encrypted registration data from the storage unit 530.

FIG. 6 is a block diagram of a UMS device 600 according to another embodiment of the present invention. A description of elements having the same names as those of FIG. 5 will be omitted here. However, in the current embodiment, an encryption unit 621 encrypts registration data together with information regarding a point of time when encryption is performed using a common key that is shared with a USB host 630, rather than producing a symmetric key using the information as a parameter.

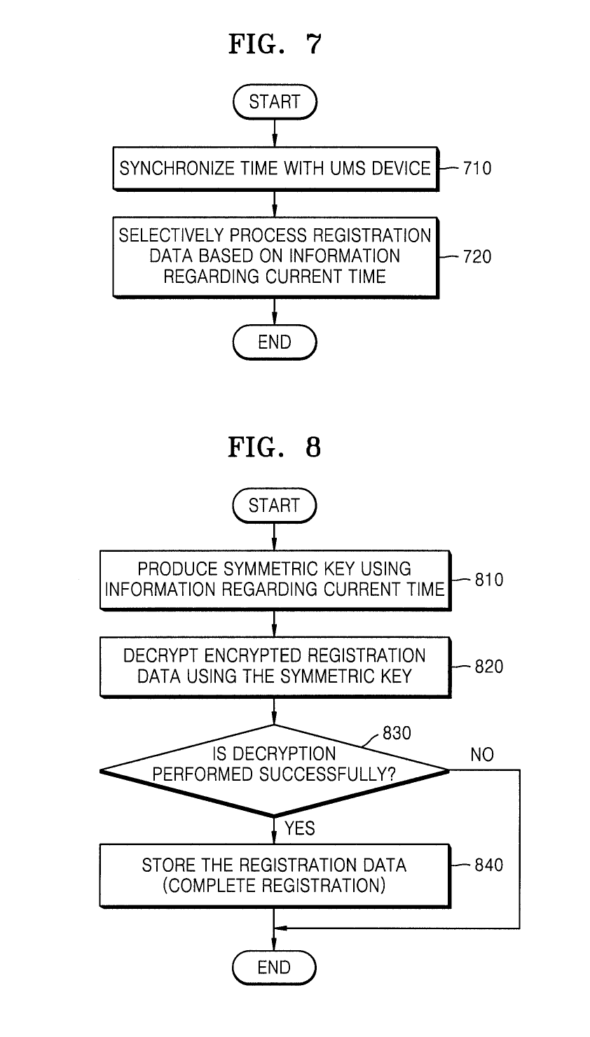

FIG. 7 is a flowchart illustrating a method of allowing a USB host to register a UMS device, according to an embodiment of the present invention.

In operation 710, a UMS device that is to be registered is synchronized with time. In this case, an external, remote time server that provides official time information may be used.

In operation 720, the USB host selectively processes registration data of the UMS device based on information regarding current time. That is, whether the UMS device is to be registered is determined based on the current time. Operation 720 will be described in detail with reference to FIG. 8.

FIG. 8 is a flowchart illustrating a method of allowing a USB host to process encrypted registration data, according to an embodiment of the present invention.

In the current embodiment, encrypted registration data is processed using the encrypting method illustrated in FIG. 3.

In operation 810, the USB host produces a symmetric key according to a predetermined key generation algorithm, using information regarding the current time. In this case, the key generation algorithm is identical to the algorithm used in the method of FIG. 3. Accordingly, the same symmetric key can be produced using information regarding any time that falls within a predetermined term of validity.

In operations 820 and 830, encrypted registration data is decrypted using the symmetric key.

If a point of time when decryption is performed, and more particularly, when the symmetric key is produced, falls within a term of validity, decryption will be performed successfully. If not, decryption will fail.

In operation 840, if decryption is performed successfully, registration data obtained as a result of decryption is stored in a secure location, thereby completing registration. That is, the USB host that stores the registration data can freely use content of the registered UMS device.

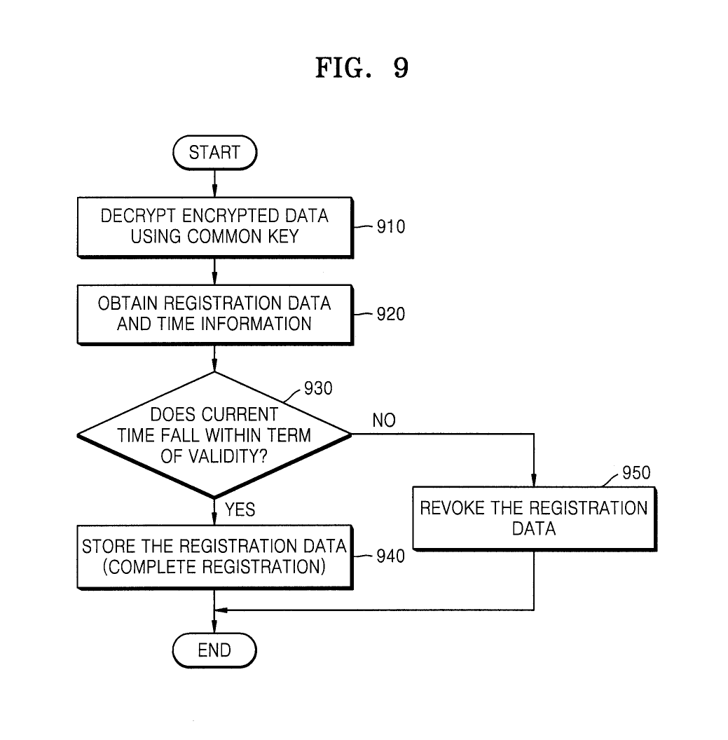

FIG. 9 is a flowchart illustrating a method of allowing a USB host to process encrypted registration data, according to another embodiment of the present invention.

In the current embodiment, encrypted registration data is processed using the encrypting method illustrated in FIG. 4.

In operation 910, the USB host decrypts encrypted data using a common key that is shared with a UMS device. The encrypted data is stored in a location of the UMS device in which registration data is stored.

In operation 920, registration data and time information are obtained as a result of decryption. The obtained time information indicates the time when encryption was performed.

In operation 930, the time information is compared with the current time when decryption is performed so as to determine whether the current time falls within a term of validity. The term of validity may be predetermined using software for registration of a UMS device.

In operation 940, if the current time falls within the term of validity, the registration data is stored in a secure location, thereby completing registration. That is, the USB host that stores the registration data can freely use content of the registered UMS device.

In operation 950, if the current time does not fall within the term of validity, the registration data is revoked. That is, although decryption is performed successfully, the UMS device cannot be registered since the registration data is revoked without being stored.

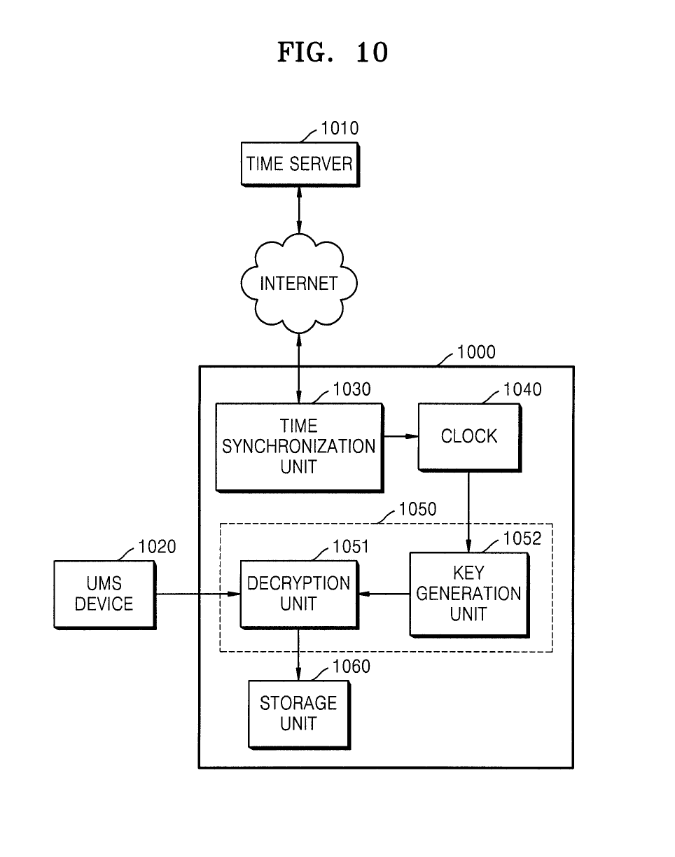

FIG. 10 is a block diagram of a USB host 1000 according to an embodiment of the present invention.

In the current embodiment, the USB host 1000 is constructed in order to decrypt encrypted registration data using the encrypting method of FIG. 3.

Referring to FIG. 10, the USB host 1000 includes a time synchronization unit 1030, a clock 1040, a registration data processor 1050, and a storage unit 1060.

The time synchronization unit 1030 synchronizes a UMS device 1020 with time. To this end, time information may be received from a remote time server 1010 via a network, such as the Internet.

The clock 1040 receives the time information from the time synchronization unit 1030 and provides it to the registration data processor 1050.

The registration data processor 1050 decrypts registration data of the UMS device 1020 by using information regarding a point of time when decryption is performed. The registration data processor 1050 includes a decryption unit 1051 and a key generation unit 1052. The key generation unit 1052 receives the information from the clock 1040 and produces a symmetric key using the information as a parameter. A key generation algorithm used in this case is identical to the algorithm used in the method of FIG. 3. Thus, the same symmetric key can be produced using information regarding any time that falls within a term of validity as a parameter.

The decryption unit 1051 decrypts the encrypted registration data of the UMS device 1020 by using the symmetric key. As described above, the decryption unit 1051 can successfully perform decryption only if a point of time when decryption is performed falls within the term of validity.

If decryption is successfully performed, the storage unit 1060 stores the registration data. The stored registration data is available for the USB host 1000 to use encrypted content of the UMS device 1020.

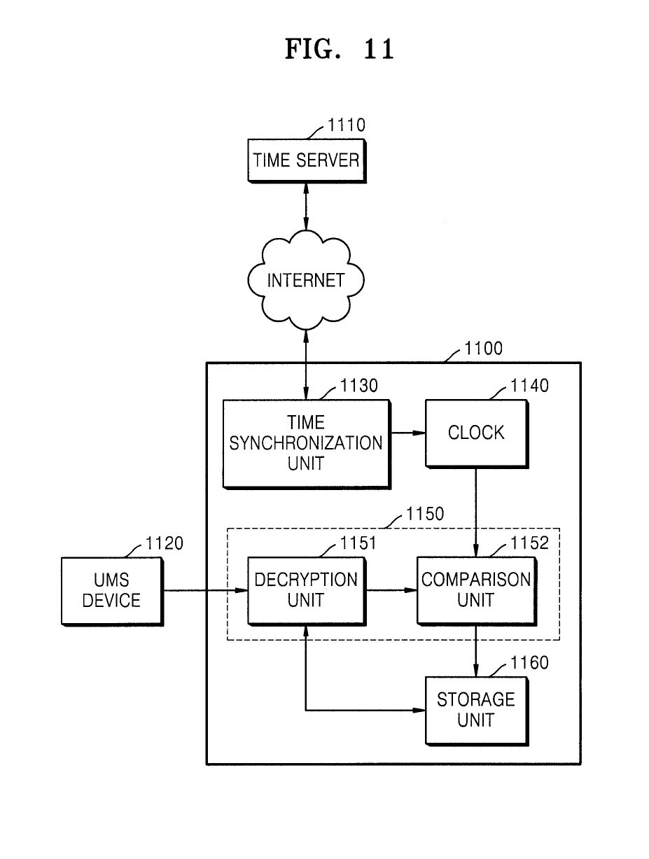

FIG. 11 is a block diagram of a USB host 1010 according to an embodiment of the present invention.

In the current embodiment, the USB host 1100 is constructed in order to decrypt encrypted registration data using the encrypting method of FIG. 4.

Referring to FIG. 11, the USB host 1100 includes a time synchronization unit 1130, a clock 1140, a registration data processor 1150, and a storage unit 1160.

The time synchronization unit 1030 synchronizes a UMS device 1120 with time. To this end, time information may be received from a remote time server 1010 via a network, such as the Internet.

The clock 1140 receives the time information from the time synchronization unit 1130 and provides it to the registration data processor 1150.

The registration data processor 1150 selectively processes registration data of the UMS device 1120 based on information regarding a point of time when decryption is performed. The registration data processor 1150 includes a decryption unit 1151 and a comparison unit 1152.

The decryption unit 1151 decrypts encrypted data of the UMS device 1120 by using a common key that has been shared between the UMS device 1120 and the USB host 1100. The encrypted data is stored in a location of the UMS device 1120 in which registration data is stored. Registration data and time information are obtained as a result of decryption. The time information indicates a point of time when the encrypted data received from the UMS device 1120 was encrypted.

The comparison unit 1152 receives information regarding current time from the clock 1140, and compares it with the time information obtained as a result of decryption so as to determine whether the current time falls within a term of validity. As described above, the term of validity may be predetermined using software for registration of a UMS device.

If the current time falls within the term of validity, the registration data is stored in the storage unit 1160, thereby completing registration. If the current time does not fall within the term of validity, the registration data is revoked without being stored.

The above embodiments of the present invention can be embodied as a computer program. The computer program may be stored in a computer-readable medium, and executed using a computer.

Examples of the computer readable medium may be any recording apparatus capable of storing data that is read by a computer system, e.g., a magnetic recording medium (ROM, a floppy disk, a hard disc, etc.), or an optical recording medium (CD-ROM, a DVD, etc.).

According to the present invention, even if encrypted registration data is disclosed, it is possible to prevent content of a UMS device from being distributed without restriction by unauthorized devices, since the encrypted registration data must be decrypted within a term of validity in order to register the UMS device.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of allowing a universal serial bus mass storage (UMS) device to manage its registration data, the method comprising:
encrypting the registration data such that the registration data is allowed to be decrypted only within a predetermined term of validity; and
storing the encrypted registration data in a predetermined location known to a universal serial bus (USB) device that accesses the UMS device;
wherein the registration data is necessary to enable use of encrypted content of the UMS device.

2. The method of claim 1, wherein the encrypting the registration data comprises:
producing a symmetric key according to a predetermined algorithm, using information regarding a current time; and
encrypting the registration data using the symmetric key;
wherein the predetermined algorithm allows the same symmetric key to be produced using information regarding anytime within a predetermined period of time beginning at the current time.

3. The method of claim 1, wherein the encrypting the registration data comprises:
encrypting the information regarding the current time and the registration data using a common key that is shared with a predetermined USB host.

4. A computer readable medium having recorded thereon a computer executable program for executing the method of allowing a universal serial bus mass storage (UMS) device to manage its registration data, the method comprising:
encrypting the registration data such that the registration data is allowed to be decrypted only within a predetermined term of validity; and
storing the encrypted registration data in a predetermined location known to a universal serial bus (USB) device that accesses the UMS device; wherein the registration data is necessary to enable use of encrypted content of the UMS device.

5. An apparatus for managing registration data of a universal serial bus mass storage (UMS) device, the apparatus comprising:
an encryption unit which encrypts the registration data such that the registration data is allowed to be decrypted only within a predetermined term of validity; and
a storage unit which stores the encrypted registration data in a predetermined location known to a universal serial bus (USB) device that accesses the UMS device;
wherein the registration data is necessary to use encrypted content of the UMS device.

6. The apparatus of claim 5, wherein the encryption unit comprises:
a key generation unit which produces a symmetric key according to a predetermined key generation algorithm, using information regarding a current time; and
a registration data encryption unit which encrypts the registration data using the symmetric key,
wherein the predetermined key generation algorithm allows the same symmetric key to be produced using information regarding anytime within a predetermined period of time beginning at the current time.

7. The apparatus of claim 5, wherein the encryption unit encrypts the information regarding a current time and the registration data using a common key that is shared with a predetermined USB host.

8. A method of allowing a USB (universal serial bus) host to register a universal serial bus mass storage (UMS) device, the method comprising:
synchronizing time with the UMS device; and
selectively obtaining registration data of the UMS device based on information regarding a current time;
wherein the registration data is necessary to enable use of encrypted content of the UMS device.

9. The method of claim 8, wherein the selectively achieving of the registration data comprises:
producing a symmetric key by processing information regarding the current time according to a predetermined key generation algorithm; and
decrypting encrypted registration data stored in a predetermined location of the UMS device using the symmetric key;
wherein the predetermined key generation algorithm allows the same symmetric key to be produced using information regarding anytime within a predetermined period of time.

10. The method of claim 8, wherein the selectively obtaining the registration data comprises:
decrypting the registration data and time information using a common key that is shared with the UMS device, where the registration data is encrypted and stored in a predetermined location of the UMS device; and
comparing the decrypted time information with information regarding the current time, and storing the decrypted registration data if a result of comparison reveals that the current time falls within a predetermined term of validity as from the decrypted time information.

11. The method of claim 8, wherein the synchronizing the time with the UMS device comprises performing synchronization using time information received from an external time server.

12. A computer readable medium having recorded thereon a program for executing the method of allowing a USB (universal serial bus) host to register a universal serial bus mass storage (UMS) device, the method comprising:
synchronizing time with the UMS device; and
selectively obtaining registration data of the UMS device based on information regarding a current time;
wherein the registration data is necessary to enable use of encrypted content of the UMS device.

13. A USB (universal serial bus) host device comprising:
a time synchronization unit which synchronizes time with a UMS (USB mass storage) device; and
a registration data processor which selectively processes registration data of the UMS device based on information regarding a current time,
wherein the registration data is necessary to use encrypted content of the UMS device.

14. The USB host device of claim 13, wherein the registration data processor comprises:
a key generation unit which produces a symmetric key by processing the information regarding the current time according to a predetermined key generation algorithm; and
a decryption unit which decrypts encrypted registration data stored in the UMS device by using the symmetric key,
wherein the key generation algorithm allows the same symmetric key to be produced using information regarding anytime that falls within a predetermined period of time.

15. The USB host device of claim 13, wherein the registration data processor comprises:
a decryption unit which decrypts the registration data and time information by using a common key that is shared with the UMS device, where the registration data is encrypted and stored in the UMS device; and
a comparison unit which compares the decrypted time information with information regarding the current time, and stores the decrypted registration data if a result of comparison reveals that the current time falls within a predetermined term of validity as from the decrypted time information and revoking the decrypted registration data if the result of comparison reveals that the current time does not fall within the term of validity.

16. The USB host device of claim 13, wherein the time synchronization unit synchronizes time with the UMS device using time information received from an external time server.

17. The method of claim 3, wherein the storing the encrypted data comprises, storing the encrypted data only if the current time falls within the pre-determined term of validity.

18. The method of claim 3, wherein the encrypted data is revoked if the current time does not fall within the pre-determined term of validity.

19. The method of claim 10, wherein the comparing further comprises revoking the decrypted registration data if the result of the comparison reveals that the current time does not fall within the term of validity.
